(19) United States
(12) Patent Application Publication
(10) Pub. No.: US 2007/0071891 A1
(43) Pub. Date: Mar. 29, 2007

(54) Cooling unit and method for cooling and coating wafer by using the same

(76) Inventors: Gyu-Myeung Lee, Yongin-si (KR); Seog-Jong Hong, Suwon-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/528,334

(22) Filed: Sep. 28, 2006

(30) Foreign Application Priority Data
Sep. 29, 2005 (KR) 2005-0091500

(51) Int. Cl. B05D 3/12; B05C 11/00; B05C 11/02

(52) U.S. Cl. 427/240; 118/52; 118/666; 118/712

(57) ABSTRACT

A cooling unit in a photolithography equipment may comprise a spin chuck module including a spin chuck configured to suction and fix a wafer. The cooling unit may also include a spin motor configured to rotate the spin chuck, the spin motor being located below the spin chuck. The cooling unit may also include a thinner spray module configured to cool the wafer to a predetermined temperature by spraying a thinner onto the wafer. The cooling unit may also include a cooling control module configured to control the cooling of the wafer.

### BACKGROUND OF INVENTION

1. Field of the Invention

The present invention generally relates to semiconductor device fabricating equipments and, more particularly, to photolithography equipment for forming a predetermined pattern on a wafer.

A claim of priority is made to Korean Patent Application No. 2005-0091500, filed Sep. 29, 2005, in the Korean Intellectual Property Office, the entirety of which is incorporated herein by reference.

2. Description of the Related Art

In general, semiconductor devices are fabricated by the combination of at least one or more layers. These layers may include, for example, a stacked conductor layer, a semiconductor layer, and an insulator layer. The fabrication may be accomplished by selectively repeating an etching process, an ashing process, a diffusion process, a deposition process, and a photolithography process on a wafer. For the purposes of this disclosure, a wafer may include, for example, a semiconductor wafer.

Of these processes, the photolithography process may include a coating process, an exposing process, and a developing process. The coating process may include coating a wafer with a photoresist. The exposing process may include scanning light onto the wafer coated with the photoresist by positioning a mask with a designed circuit-pattern on the wafer. The developing process may include distinguishing an exposed portion from an unexposed portion by the light scanned during the exposing process and selectively removing the photoresist using a developing solution.

Photolithography equipment for the photolithography process may be divided into two systems. The two systems may be, for example, a coating and developing system known as a spinner, and an exposure system known as a scanner or a stepper. The spinner and the scanner may be in-line linked in order to perform the photolithography process.

The spinner may include a number of units configured to perform portions of the spinning process. These units may include, for example, a spin coater unit for forming an ARC (anti-reflective coating) layer on a wafer or for forming a photoresist layer on a wafer, to perform the coating process; a cool plate unit for cooling the wafer; a hot plate unit for heating the wafer; a soft bake unit for hardening the photoresist coating on the wafer; and a transfer unit for transferring the wafer between each unit. Furthermore, the spinner may also include a number of units in addition to the above-described units to perform the developing process.

The spinner may perform the coating process in a number of ways. For example, in one method, after completing a predetermined prior process on the wafer, the wafer may be transferred to the spin coater unit where the ARC layer may be formed on the wafer. The wafer coated with the ARC layer may then be transferred to the hot plate unit which may heat the wafer. The heated wafer may be transferred to the cool plate unit and cooled to normal temperature (about 23° C.). The cooled wafer may be transferred back to the spin coater unit and coated with the photoresist layer. After coating the wafer with the photoresist, the wafer may be transferred to the soft bake unit. The soft bake unit may harden the photoresist layer. The wafer with the hardened photoresist may be transferred back to the cool plate unit where it may be cooled again, thereby completing the coating process.

While the prior art photolithography equipment may perform photolithography, it has several shortcomings. For example, in conventional photolithography equipment, the number of transfer units for transferring the wafer between each unit may be limited in comparison to the number of bake units, i.e., the cool plate unit, hot plate unit, and soft bake unit. This low number of transfer units may cause a delay in the production time of semiconductor devices, thereby lowering the rate of production of semiconductor devices.

### SUMMARY OF THE INVENTION

One aspect of the disclosure includes a cooling unit in a photolithography equipment. The cooling unit comprises a spin chuck module including a spin chuck configured to suction and fix a wafer. The cooling unit may also include a spin motor configured to rotate the spin chuck, the spin motor being located below the spin chuck. The cooling unit may also include a thinner spray module configured to cool the wafer to a predetermined temperature by spraying a thinner onto the wafer. The cooling unit may also include a cooling control module configured to control the cooling of the wafer.

Another aspect of the present disclosure includes a photolithography equipment including a coater which coats a wafer with a photoresist layer. The coater may include a cooling and coating unit configured to cool the wafer by using a thinner and spray a photoresist layer onto the wafer. The coater may also include a bake unit configured to harden the photoresist on the wafer. The coater may also include a cool plate unit configured to cool the wafer. The coater may also include a transfer unit configured to transfer the wafer to at least one of the cooling and coating unit, the bake unit, and the cool plate unit.

Yet another aspect of the present disclosure includes a method for cooling a wafer. The method may include suctioning and fixing a wafer onto a spin chuck. The method may also include rotating the wafer by rotating a spin motor connected with the spin chuck. The method may also include spraying a thinner onto the wafer with a thinner spray module. The method may also include controlling the cooling of the wafer with a cooling control module.

### BRIEF DESCRIPTION OF THE DRAWINGS

The above and other features of the present invention will become more apparent to those of ordinary skill in the art by describing in detail preferred embodiments thereof with reference to the attached drawings in which:

FIG. 1 is a structural view of photolithography equipment according to an exemplary disclosed embodiment;

FIGS. 2A and 2B are perspective views illustrating a cooling and coating unit of FIG. 1;

FIG. 3 is a sectional view taken along the line I-l′ of FIG. 2A;

FIG. 4 is a structural view of a thinner spray module of the cooling and coating unit according to an exemplary disclosed embodiment;

FIG. 5 is a block diagram illustrating a cooling control module of the cooling and coating unit according to an exemplary disclosed embodiment;

FIGS. 6A, 6B and 6C illustrate control relations by a temperature sensor of the cooling and coating unit according to an exemplary disclosed embodiment;

FIG. 7 is a flow chart illustrating a method of coating a wafer by using the cooling and coating unit according to an exemplary disclosed embodiment; and

FIG. 8 is a flow chart illustrating a method of coating a wafer by using the cooling and coating unit according to an alternative exemplary disclosed embodiment.

### DETAILED DESCRIPTION OF EXEMPLARY EMBODIMENTS

The present invention will now be described more fully hereinafter with reference to the accompanying drawings, in which preferred embodiments of the invention are shown. This invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the thicknesses of layers and regions are exaggerated for clarity. Like numbers refer to like elements throughout the specification.

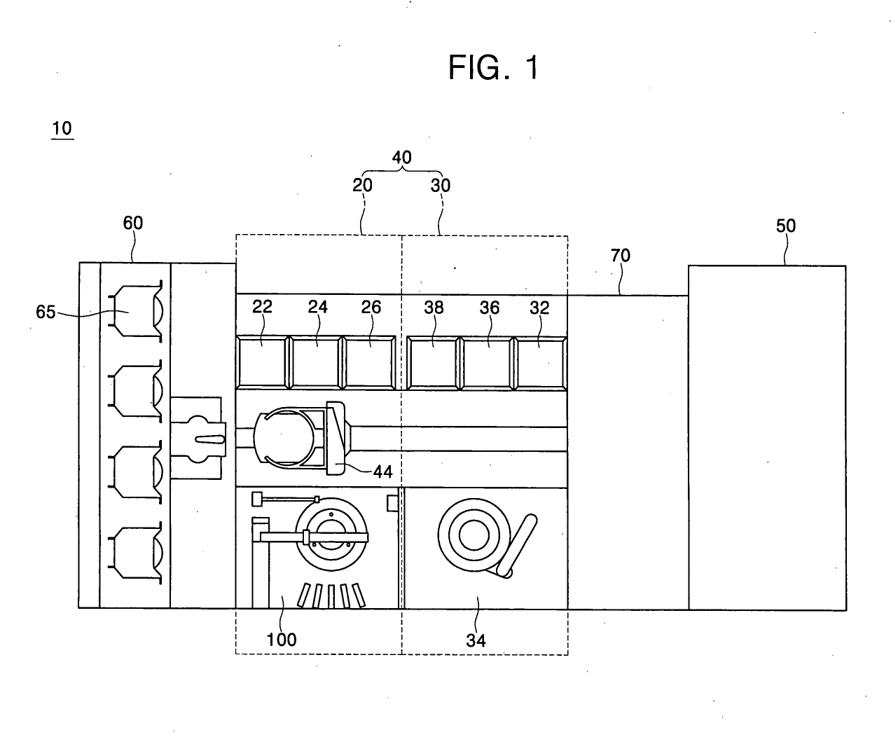

FIG. 1 provides a structural view of photolithography equipment 10. Photography equipment 10 includes a number of components. In an exemplary embodiment, photolithography equipment 10 may include a spinner 40 and an exposure apparatus 50. The spinner 40 may include a coater 20, a developer 30, and a transfer unit 44. The coater 20 may be configured to coat a wafer with a photoresist layer. The developer 30 may be configured to selectively remove the photoresist on the wafer such that a predetermined pattern is exposed by the exposure apparatus 50. The transfer unit 44 may be configured to transfer a wafer from one unit to another in the spinner 40. In an exemplary embodiment, the transfer unit 44 may transfer a wafer between the coater 20 and the developer 30. In addition, the transfer unit 44 may transfer a wafer between any other units of the spinner 40. The exposure apparatus 50 is configured to perform an exposing process. This process may include positioning a mask with a designed circuit pattern on the wafer coated with the photoresist and scanning light on the wafer.

The photolithography equipment 10 may further include an indexer 60 and an interface 70. The indexer 60 may be configured to hold one or more wafers. In an exemplary embodiment, the indexer 60 may be loaded with a cassette 65 having a number of stacked wafers and may be positioned at one side of the spinner 40. The interface 70 may be configured to transfer a wafer between each unit of the photolithography equipment 10. In an exemplary embodiment, the interface 70 may be positioned between the spinner 40 and the exposure apparatus 50.

The coater 20 may include a low hot plate unit 22, a soft bake unit 24, a cool plate unit 26, and a cooling and coating unit 100. The low hot plate unit 22 may be configured to heat a wafer at a predetermined temperature. The cooling and coating unit 100 may be configured to cool the wafer by spraying an ARC (anti-reflective coating) layer. Alternatively, the cooling and coating unit 100 may cool the wafer by using a thinner. Furthermore, the cooling and coating unit 100 may be configured to cool the wafer using any other suitable cooling process. In addition to cooling, the cooling and coating unit 100 may be configured to spray a photoresist onto the wafer. The soft bake unit 24 may be configured to harden the wafer coated with the photoresist layer. The cool plate unit 26 may be configured to cool the hardened wafer.

The developer 30 may include a post exposure bake unit 32, a spin developer unit 34, a hot plate unit 36, and a cool plate unit 38. The post exposure bake unit 32 may be configured to harden the wafer. In an exemplary embodiment, this hardening may be accomplished after the exposure process. The spin developer unit 34 may be configured to remove at least a portion of the. photoresist layer on the wafer. The hot plate unit 36 may also be configured to harden the wafer. In an exemplary embodiment, the hot plate unit 36 may harden the wafer from which at least a portion of the photoresist layer is removed. The cool plate unit 38 may be configured to cool the hardened wafer.

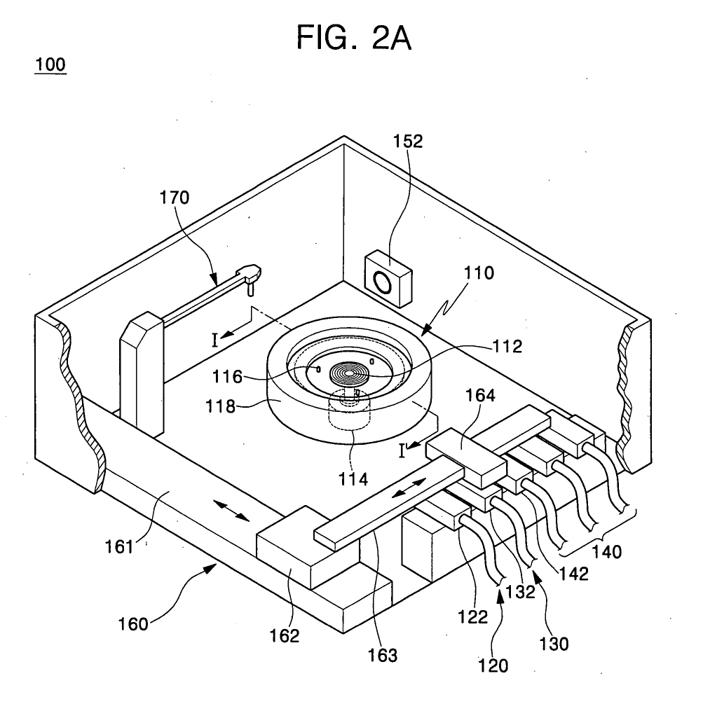

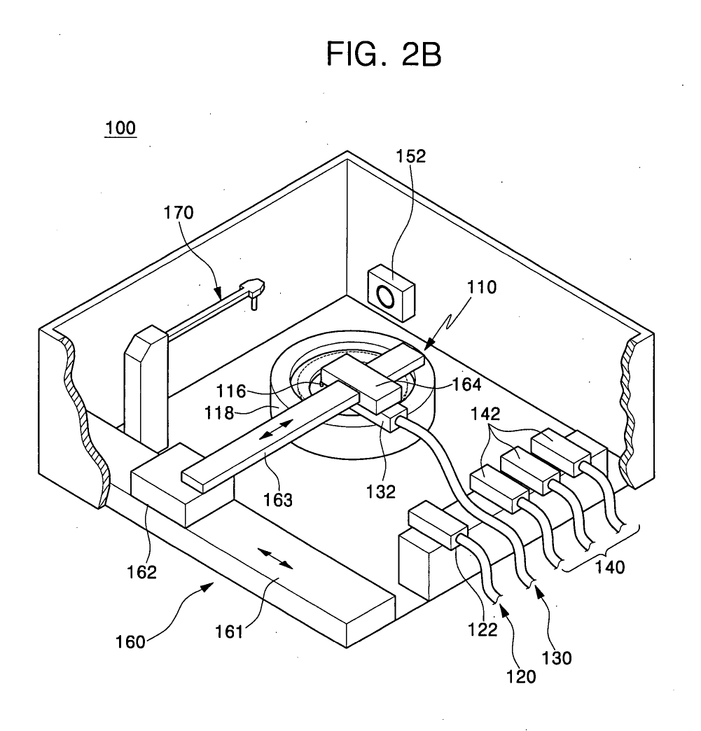

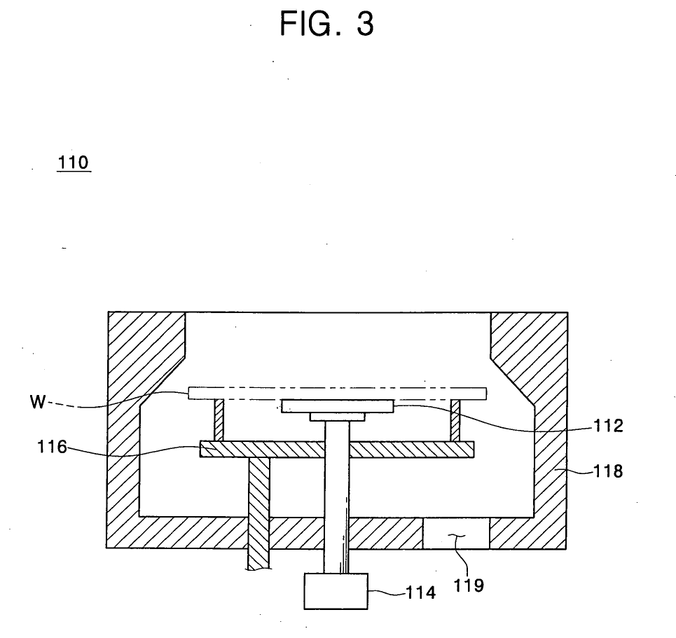

With reference to FIGS. 2A, 2B and 3, the cooling and coating unit 100 may include a spin chuck module 110, an ARC spray module 120, a thinner spray module 130, a photoresist spray module 140, and a cooling control module 150 (not shown). The spin chuck module 110 may be configured to hold and rotate the wafer. Holding may include directly, indirectly, wholly, or partially fixing the wafer on the spring chuck module using one or more fixing mechanisms. In an exemplary embodiment, the wafer may be suctioned on to the spin chuck module with a suction element (not shown). The ARC spray module 120 may be configured to spray an ARC layer on the wafer. The thinner spray module 130 may be configured to cool the wafer to a predetermined temperature by spraying a thinner onto the wafer. The photoresist spray module 140 may be configured to coat the wafer with a photoresist layer by spraying a photoresist on the wafer. The cooling control module 150 may be configured to control the cooling of the wafer by sensing the temperature of the wafer.

The spin chuck module 110 may include a spin chuck 112, a spin motor 114, a lift pin 116, and a coater cup 118. The spin chuck 112 may be configured to hold a wafer by suctioning the wafer to the spin chuck 112. The spin motor 114 may be configured to rotate the wafer fixed-to the spin chuck 112. The lift pin 116 may be configured to hold the wafer on to the spin chuck 112. The coater cup 118 may be formed outside the spin chuck 112.

The spin chuck 112 may include a vacuum suction element (not shown) to create a vacuum and thereby fix the wafer to the spin chuck 112. The spin motor 114 may be positioned below the spin chuck 112 and may be connected with the spin chuck 112 to rotate the spin chuck 112. When predetermined chemicals, such as, for example, ARC, thinner and photoresist, are sprayed onto the wafer which rotates and is fixed to the spin chuck 112, the coater cup 118 prevents the sprayed chemicals from flowing outside. This may prevent other units or the surroundings from being contaminated. The coater cup 118 may include an exhausting port 119. Exhausting port 119 may be configured to guide the chemicals that are scattered after being sprayed such that the chemicals are exhausted out of the cooling and coating unit 100.

In an exemplary embodiment, the ARC spray module 120, the thinner spray module 130, and the photoresist spray module 140 may be positioned at one side of the spin chuck module 110. Furthermore, these modules may be used to spray chemicals, such as, for example, ARC, thinner and photoresist, on the wafer. In addition, these chemicals may be sprayed in accordance with a predetermined sequence of the coating process.

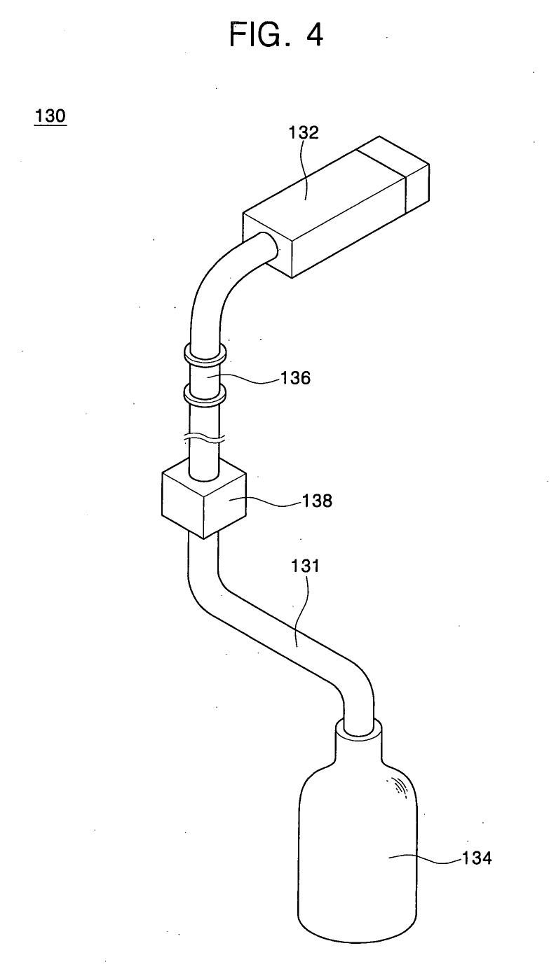

FIG. 4 provides a structural view of the thinner spray module 130. The thinner spray module 130 may include a thinner storage bath 134, a thinner nozzle 132, a thinner pipe 131, a pump 138, and a flow control valve 136. The thinner storage bath 134 may be configured to store a thinner. The thinner nozzle 132 may be configured to spray the thinner onto the wafer. The thinner pipe 131 may be configured to connect the thinner storage bath 134 to the thinner nozzle 132. The pump 138 may be positioned on the thinner pipe 131. In addition, the pump 138 may be configured to transfer the thinner to the thinner nozzle 132. The flow control valve 136 may be positioned on the thinner pipe 131. The flow control valve may be configured to control the flow of the thinner between the thinner pipe 131 and the thinner nozzle 132.

One skilled in the art will appreciate that similar to thinner spray module 130, the ARC spray module 120 and the photoresist spray module 140 may also include the following: storage baths configured to store chemicals such as, for example, ARC and photoresist; spray nozzles 122 and 142 configured to spray chemicals onto the wafer; pipes configured to connect the storage bath and the spray nozzle; and pumps and valves positioned on the pipes.

Referring to FIGS. 2A and 2B, the thinner nozzle. 132, the ARC nozzle 122, and the photoresist nozzles 142 are shown with respect to the spray modules 120, 130, and 140, respectively. The photoresist spray module 140 may include a number of photoresist nozzles 142. The number of photoresist modules may depend on the concentration of the photoresist.

The cooling and coating unit 100 may include a nozzle arm 160. The nozzle arm 160 may be configured to move the thinner nozzle 132, the ARC nozzle 122, and the photoresist nozzles 142 above the wafer. This movement may be accomplished by selective vacuum-suction of the nozzles in accordance with a sequence of the coating process. The nozzle arm 160 may include a first movable body 162 moving along an X-axis guide rail 161 and a second movable body 164 moving along a Y-axis guide rail 163 positioned on the first movable body 162. The vacuum suction element may be positioned below the second movable body 164.

Furthermore, based on the sequence in which the coating process is to be performed, the vacuum suction element may selectively cause the movement of each of the spray nozzles 122, 132, and 142 above the wafer. In order to cool the wafer by spraying the thinner onto the wafer, the nozzle arm 160 may first move the thinner nozzle 132 above the wafer. Then, the pump 138 on the thinner pipe 131 may operate so that the flow control valve 136 is opened to transfer the thinner stored in the thinner storage bath 134 to the thinner nozzle 132. Then, the thinner may be sprayed onto the wafer through the thinner nozzle 132. The sprayed thinner may remove the heat from the wafer by evaporation. This evaporation of heat may cool the wafer.

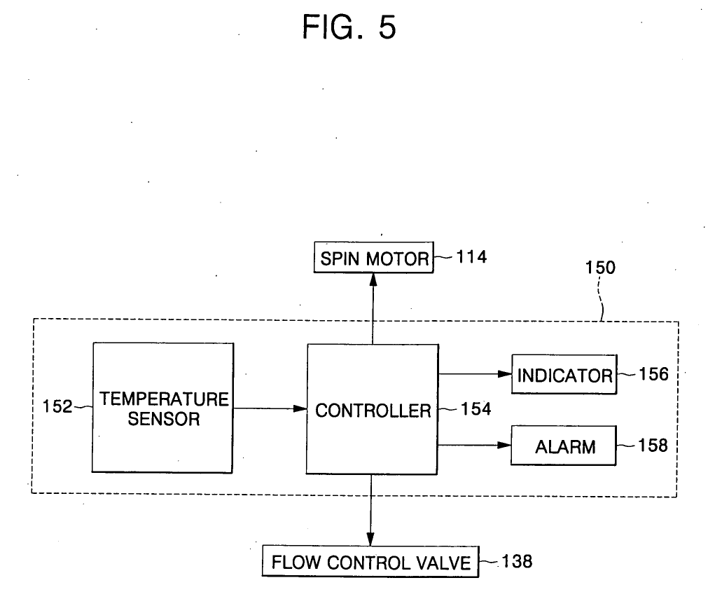

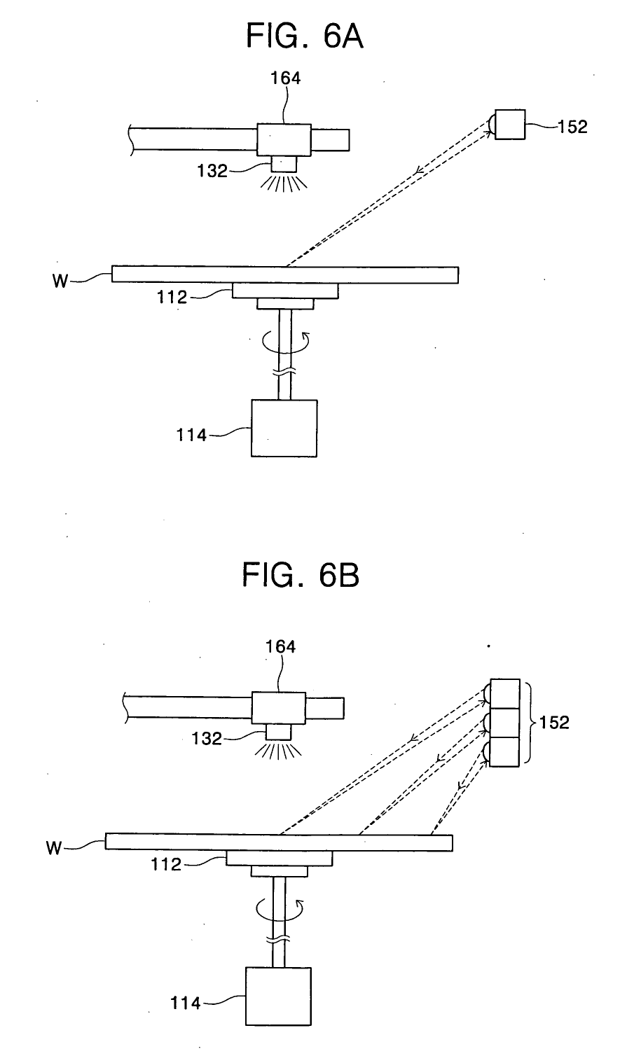

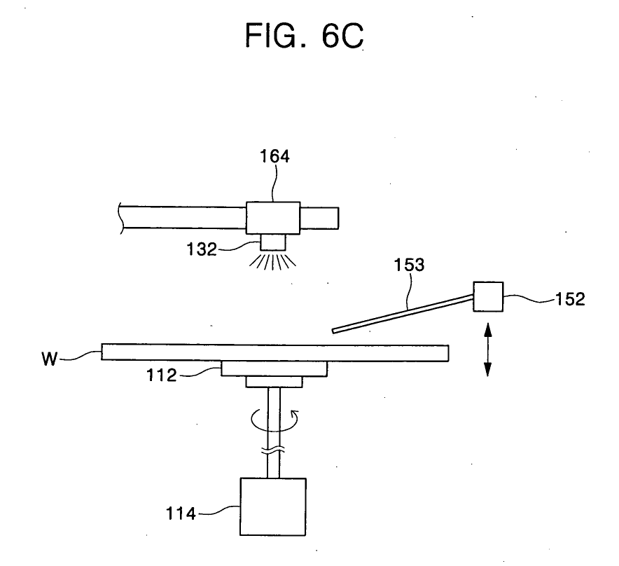

With reference to FIGS. 5 and 6A, the cooling control module 150 may include a temperature sensor 152, a controller 154, a display device 156, and an alarm device 158. The temperature sensor 152 may be configured to sense the temperature of the wafer. The controller 154 may be configured to control the cooling of the wafer by comparing a temperature value sensed by the temperature sensor 152 to a predetermined temperature value. The display device 156 may be configured to display the temperature value sensed by the temperature sensor 152. The alarm device 158 may be configured to generate an alarm when the temperature is sensed as being higher than the predetermined temperature. Specifically, the temperature sensor 152 may be positioned above the spin chuck 112 and may be configured to sense the temperature of the wafer in the process of cooling the wafer. In an exemplary embodiment, the temperature sensor 152 may be a non-touch sensor so as not to be damaged by the thinner spray and the rotation of the spin chuck 112.

Various types of non-touch sensors may be used as the temperature sensor 152. For example, the non-touch temperature sensor may be an infrared sensor sensing the temperature of the wafer by emitting infrared rays onto the wafer, an ultraviolet sensor sensing the temperature of the wafer by emitting ultraviolet rays onto the wafer, or a radiant heat sensor sensing the radiant heat generated from the wafer.

The controller 154 may be electrically connected with the temperature sensor 152, the display device 156, the alarm device 158, the spin motor 114, and the flow control valve 136 of the thinner spray module 130.

In an exemplary embodiment, the wafer held on to the spin chuck 112 is rotated and is cooled by spraying the thinner onto the rotating wafer. In the process of cooling the wafer, the temperature sensor 152 may sense the temperature value of the wafer and transfer the sensed temperature value to the controller 154. The controller 154 may compare the sensed temperature value of the wafer to the predetermined temperature value, which may include, for example, the normal temperature.

When the temperature of the wafer sensed by the temperature sensor 152 is higher than the normal temperature, the controller 154 may control the flow control valve 136 of the thinner spray module 130 such that the flow of the thinner moving through the thinner pipe 131 is increased, thereby cooling the wafer to the normal temperature.

Furthermore, the controller 154 may control the rotation speed of the spin chuck 112 that holds the wafer, thereby cooling the wafer. The controller 154 may control the rotation speed of the spin chuck 112 by controlling the spin motor 114 that rotates the spin chuck 112. When the temperature of the wafer is kept at the normal temperature by controlling the flow of the thinner and/or the rotation speed of the spin chuck 112, the controller 154 may stop operating the spin motor 114 and close the flow control valve 136 to stop supplying the thinner. At this time, the cooling of the wafer is complete.

FIG. 6A illustrates a control relation between the temperature sensor 152 and the coating and cooling unit 100. During the process of cooling the wafer, the temperature sensor 152 may sense the temperature of the wafer by emitting infrared rays or ultraviolet rays on to the middle of the wafer (onto which the thinner is sprayed) and by receiving the infrared rays or ultraviolet rays reflected from the wafer. In an exemplary embodiment, as shown in FIG. 6B, three temperature sensors 152 may be arranged to emit the infrared rays or ultraviolet rays. Each temperature sensor 152 may be configured to emit light on to a separate region of the wafer. For example, a first sensor may emit light on to the middle, the second on to the edge, and the third between the middle and the edge of the wafer, on to which the thinner is sprayed. The emitted infrared rays or ultraviolet rays may be reflected back by the wafer to the temperature sensors 152. The controller 154 may sense the temperature of the wafer by calculating an average of the temperature values of the wafer sensed at these portions of the wafer.

In an alternative exemplary embodiment, temperature sensor 152 may be a radiant heat sensor. As shown in FIG. 6C, when the temperature sensor 152 is a radiant heat sensor, the temperature sensor 152 may sense the temperature of the wafer by sensing the radiant heat generated from the wafer. The radiant heat may be sensed by utilizing a probe 153 placed close to the wafer on to which the thinner is sprayed.

The coating and cooling unit 100 may include an edge bead rinse module 170. The photoresist layer coated on the edge of the wafer may release particles or cause a pattern failure in the processes after the etching or ion-implanting process. As shown in FIGS. 2A and 2B, the edge bead rinse module 170 may be configured to remove the photoresist layer coated on the edge of the wafer. Furthermore, an air supply module (not shown) may be positioned above the cooling and coating unit 100 to supply air above the wafer. This air may be used to control temperature and humidity in the cooling and coating unit.

In an alternative exemplary embodiment, the spinner 40 may include an ARC layer unit (not shown). This may be different than the above-mentioned configuration in which the ARC spray module 120 is included in the cooling and coating unit 100. Thus, it is possible to form the ARC layer using a separate ARC layer unit instead of using the cooling and coating unit 100.

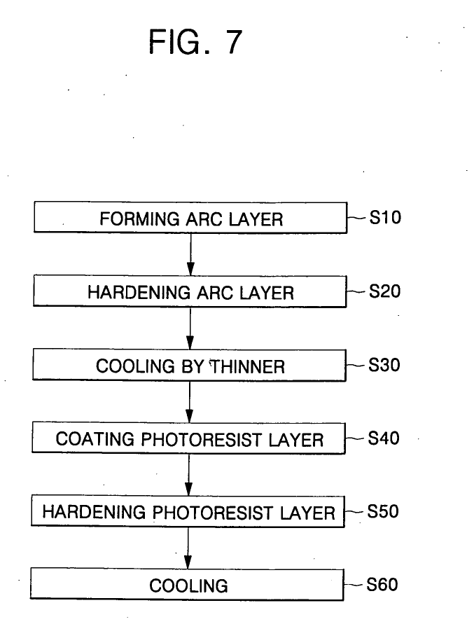

FIG. 7 is a flowchart illustrating the steps of an exemplary disclosed method for coating a wafer by using the cooling and coating unit 100. Specifically, at step 10, a wafer is transferred to the cooling and coating unit 100, and an ARC layer is formed on the wafer.

At step 20, the wafer on which the ARC layer is formed is transferred to the low hot plate unit 22, and the ARC layer is hardened by heating the wafer at a predetermined low temperature.

At step 30, the wafer on which the ARC layer is hardened is cooled to a predetermined temperature, e.g., normal temperature, by the thinner spray module 130 and the cooling control module 150.

For the above-mentioned steps, the wafer is first held to the spin chuck 112 of the spin chuck module 110. The wafer is rotated by rotating a spin motor 114 connected with the spin chuck 112. The nozzle arm 160 moves the thinner nozzle 132 of the thinner spray module 130 above the wafer. A thinner stored in the thinner storage bath 134 is transferred to the thinner nozzle 132 by operating the pump 138 positioned on the thinner pipe 131. The thinner is sprayed onto the wafer through the thinner nozzle 132 placed above the wafer. The thinner sprayed onto the wafer cools the wafer by removing the heat from the wafer by evaporation

During the process of spraying the thinner, when the temperature of the wafer sensed by a temperature sensor 152 is higher than a predetermined temperature, e.g., normal temperature, the cooling control module 150 controls at least one of the flow control valve 136 and the rotation speed of the spin chuck 112, thereby cooling the temperature of the wafer to the normal temperature. When the temperature of the wafer is cooled to the normal temperature, the controller 154 stops the rotation of the spin motor 114 to stop rotating the wafer and stops the operation of the thinner spray module 130 to stop spraying the thinner on to the wafer.

When the temperature of the wafer is kept at the normal temperature by spraying the thinner, then, at step 40, the wafer is coated with a photoresist layer by the photoresist spray module 140.

After coating the wafer with a photoresist layer, then, at step 50, the wafer is transferred to the soft bake unit 24 and the photoresist layer is hardened.

When the photoresist layer is hardened, then, at step 60, the wafer is transferred to the cool plate unit 26 and the thinner is sprayed onto the wafer, thereby performing the cooling process and completing the coating process with respect to the wafer.

The coating method according to the exemplary disclosed embodiments may reduce the time for the coating process because the cooling process of the wafer is performed before the coating of the photoresist layer. The coating time may also be reduced because the photoresist layer is coated within the cooling and coating unit without moving the cooled wafer from one unit to another.

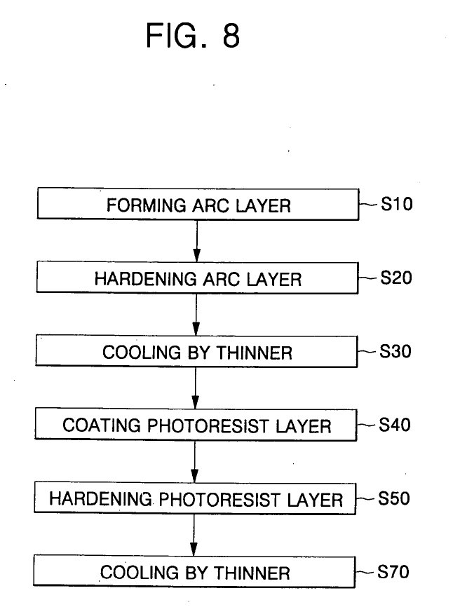

FIG. 8 provides an illustration of a method of coating a wafer in accordance with an alternative exemplary embodiment. The method according to the embodiment in FIG. 8. is performed in the same sequence of step 10 through step 50 as the method according to the embodiment in FIG. 7. However, after steps 10 through 50, the wafer on which the photoresist is hardened may be transferred back to the cooling and coating unit 100 and may be cooled in the cooling and coating unit 100 (S70). This may eliminate the need for a separate cool plate unit in the photolithography equipment. Specifically, this may eliminate the need for a cool plate unit in the coater of the spinner 40.

The coating method according to the embodiment in FIG. 8 may reduce the time for the coating process by performing the cooling process of the wafer before the coating process. The coating process time may also be reduced by performing the cooling process after the coating process, but in the cooling and coating unit. Performing the cooling process in the cooling and coating unit may reduce the number of units between which the wafer has to be sent. This reduction in the number of units may also lead to a reduction in the size of the photolithography equipment.

As described above, the present invention may have the effect of shortening the time for transferring a wafer between different units in photolithography equipment because cooling of the wafer and coating of the wafer with the photoresist layer is accomplished in one unit, i.e.,. cooling and coating unit.

Furthermore, the present invention may have the effect of increasing the production yield of semiconductor devices by shortening the transfer time of the wafer between the different units in the photolithography equipment.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A cooling unit in a photolithography equipment, the cooling unit comprising:
a spin chuck module including a spin chuck configured to suction and fix a wafer;
a spin motor configured to rotate the spin chuck, the spin motor being located below the spin chuck;
a thinner spray module configured to cool the wafer to a predetermined temperature by spraying a thinner onto the wafer; and
a cooling control module configured to control the cooling of the wafer.

2. The cooling unit according to claim 1, wherein the cooling control module comprises:
a temperature sensor configured to sense a temperature of the wafer; and
a controller configured to control the cooling of the wafer by controlling at least one of a flow of the thinner and the rotation of the spin chuck based on the temperature sensed by the temperature sensor and a predetermined temperature.

3. The cooling unit according to claim 2, wherein the temperature sensor is a non-touch sensor.

4. The cooling unit according to claim 3, wherein the temperature sensor is positioned above the spin chuck.

5. The cooling unit according to claim 4, wherein the temperature sensor is a sensor configured to sense at least one of infrared rays, ultraviolet rays, and radiant heat.

6. The cooling unit according to claim 4, wherein the cooling control module further includes a display device configured to display the temperature of the wafer sensed by the temperature sensor, and an alarm device configured to generate an alarm when the temperature of the wafer is sensed as being higher than the predetermined temperature, wherein the display device and the alarm device are controlled by the controller.

7. Photolithography equipment including a coater which coats a wafer with a photoresist layer, wherein the coater comprises:
a cooling and coating unit configured to: cool the wafer by using a thinner; and spray a photoresist layer onto the wafer;
a bake unit configured to harden the photoresist on the wafer;
a cool plate unit configured to cool the wafer; and
a transfer unit configured to transfer the wafer to at least one of the cooling and coating unit, the bake unit, and the cool plate unit.

8. The photolithography equipment according to claim 7, wherein the cooling and coating unit includes:
a spin chuck module including a spin chuck configured to suction and fix a wafer;
a spin motor configured to rotate the spin chuck, the spin motor being located below the spin chuck;
a thinner spray module configured to cool the wafer to a predetermined temperature by spraying a thinner onto the wafer; and
a cooling control module configured to control the cooling of the wafer.

9. The photolithography equipment according to claim 8, wherein the thinner spray module includes a thinner nozzle configured to spray the thinner onto the wafer and a flow control valve configured to control a flow of the thinner through the thinner nozzle.

10. The photolithography equipment according to claim 8, wherein the cooling control module comprises:
a temperature sensor configured to sense a temperature of the wafer; and
a controller configured to control the cooling of the wafer by controlling at least one of a flow of the thinner and the rotation of the spin chuck based on the temperature sensed by the temperature sensor and a predetermined temperature.

11. The photolithography equipment according to claim 8, wherein the cooling and coating unit further includes:
a photoresist spray module configured to coat the wafer with a photoresist layer by spraying the photoresist layer on the wafer; and
an anti-reflective coating (ARC) spray module configured to coat the wafer with an ARC layer.

12. The photolithography equipment according to claim 11, wherein the cooling and coating unit further includes a nozzle arm configured to move a nozzle in at least one of the ARC spray module, the photoresist spray module, and the thinner spray module above the wafer.

13. The photolithography equipment according to claim 12, wherein the cooling and coating unit further includes an edge bead rinse module configured to remove at least a portion of the photoresist on an edge of the photoresist layer on the wafer.

14. A method for cooling a wafer comprising:
suctioning and fixing a wafer onto a spin chuck;
rotating the wafer by rotating a spin motor connected with the spin chuck;
spraying a thinner onto the wafer with a thinner spray module; and
controlling the cooling of the wafer with a cooling control module.

15. The cooling method according to claim 14, wherein the cooling of the wafer is controlled by controlling at least one of a flow of the thinner in the thinner spray module and the rotation of the spin motor with the cooling control module.

16. A method of coating a wafer comprising:
holding a wafer onto a spin chuck;
cooling the wafer by spraying a thinner onto the wafer, wherein the wafer rotates along with the spin chuck; and
coating the wafer with a photoresist.

17. The coating method according to claim 16, wherein the cooling of the wafer further comprises:
rotating the wafer by rotating a spin motor connected with the spin chuck;
spraying the thinner onto the rotating wafer through a thinner spray module; and
controlling the cooling of the wafer with a cooling control module.

18. The coating method according to claim 16, further comprising:
forming an anti-reflective coating (ARC) layer on the wafer before cooling the wafer; and
hardening the wafer including the ARC layer in a low hot plate unit, wherein the cooling of the wafer is accomplished on the spin chuck.

19. The coating method according to claim 16, further comprising:
hardening the wafer coated with the photoresist layer; and
cooling the hardened wafer.
